(19) United States
(12) Patent Application Publication
(10) Pub. No.: US 2016/0024759 A1
(43) Pub. Date: Jan. 28, 2016

(54) Method of Managing the Internal Fluid Movement of a Building

(71) Applicant: Ramu Vinjamaram, Irving, TX (US)

(72) Inventor: Ramu Vinjamaram, Irving, TX (US)

(21) Appl. No.: 14/808,874

(22) Filed: Jul. 24, 2015

Related U.S. Application Data
(60) Provisional application No. 62/029,015, filed on Jul. 25, 2014.

(51) Int. Cl. E03B 7/10; E03B 7/04; G05D 7/06; E03B 7/07

(52) U.S. Cl. CPC E03B 7/10; E03B 7/071; E03B 7/04; G05D 7/0635

(57) ABSTRACT

A method of managing the internal fluid movement of a building is utilized to prevent the bursting of pipes in a plumbing system from freezing. An at least one water dripping circulation device is utilized to circulate water through the plumbing system in order to prevent the pipes in the plumbing system from freezing. In the event of an emergency situation within the building such as flooding from a burst pipe, an electronic shut-off valve is utilized to disable the flow of water into the building, preventing further damage due to the flooding. Current water conditions and current environmental conditions are monitored in order to automatically circulate water through the plumbing system or disable the flow of water into the building. A user command may be transmitted to the at least one water dripping circulation device and the electronic shut-off valve as well for manual control.

The current application claims a priority to the U.S. Provisional Patent application Ser. No. 62/029,015 filed on Jul. 25, 2014.

### FIELD OF THE INVENTION

The present invention relates generally to a system and method for preventing the bursting of water lines in a building. More specifically, the present invention is a method of managing the internal fluid movement of a building that controls water flow within the building in order to prevent water pipe freezing and resultant flooding.

### BACKGROUND OF THE INVENTION

The expansion of water during freezing often results in significant pressure being exerted on the vessel in which the water is contained. This is particularly problematic during the winter seasons when water freezes inside pipes and exerts pressure on the pipes, resulting in potential bursting of the pipes. Burst pipes alone are inconvenient and expensive to fix. However, the burst pipes are also capable of causing severe damage to a building due to flooding. Frozen pipes may be avoided by a variety of precautionary measures. It is important to ensure that areas of a building where water lines are located do not experience temperatures below freezing. One of the most common methods of preventing frozen pipes is by circulating the water in a pipe by turning on a faucet. This allows water to flow through the pipe and in turn lowers the internal pressure within the pipe. Simply allowing water to trickle through the pipe is enough to prevent the pipe from freezing. However, water faucets must be turned on fairly regularly or left continuously running. While this solution is effective and straightforward, the solution is both wasteful and expensive to implement on a regular basis.

The present invention is a method of managing the internal fluid movement of a building that is primarily designed to prevent the freezing and bursting of pipes. The present invention allows for the automated and/or remote management of water flow in the building. The present invention is able to take into consideration many factors including, but not limited to, reports of local weather conditions, user GPS (Global Positioning System) location, and saved data relating to the water flow within the building.

### BRIEF DESCRIPTION OF THE DRAWINGS

FIG. 1 is a diagrammatic overview of the present invention.

FIG. 2A is a flowchart illustrating the overall process that is followed by the present invention.

FIG. 2B is a continuation of the flowchart illustrated in FIG. 2A.

FIG. 3 is a flowchart illustrating the secondary process that is followed by the present invention when a water pressure sensor is utilized to monitor an internal water pressure of the plumbing system.

FIG. 4 is a flowchart illustrating the secondary process that is followed by the present invention when a temperature sensor is utilized to monitor an internal water temperature of the plumbing system.

FIG. 5 is a flowchart illustrating the secondary process that is followed by the present invention when a liquid leak sensor is utilized to monitor the surrounding areas of the plumbing system.

FIG. 6 is a flowchart illustrating the secondary process that is followed by the present invention when a video-capture device is utilized to monitor the surrounding areas of the plumbing system.

FIG. 7 is a flowchart illustrating the secondary process that is followed by the present invention when the possible freezing condition is indicated by a local forecasted temperature.

FIG. 8 is a flowchart illustrating the secondary process that is followed by the present invention when the local forecasted temperature is determined based on a geographical location.

FIG. 9 is a flowchart illustrating the secondary process that is followed by the present invention when a user command is sent to the at least one water dripping circulation device.

FIG. 10 is a flowchart illustrating the secondary process that is followed by the present invention when a user command is sent to the electronic shut-off valve.

FIG. 11 is a diagram of the at least one water dripping circulation device.

FIG. 12 is a flowchart depicting the secondary process that is followed by the present invention when a quantity of cold water is circulated through the at least one water dripping circulation device.

FIG. 13 is a flowchart depicting the secondary process that is followed by the present invention when a quantity of hot water is circulated through the at least one water dripping circulation device.

### DETAIL DESCRIPTIONS OF THE INVENTION

All illustrations of the drawings are for the purpose of describing selected versions of the present invention and are not intended to limit the scope of the present invention.

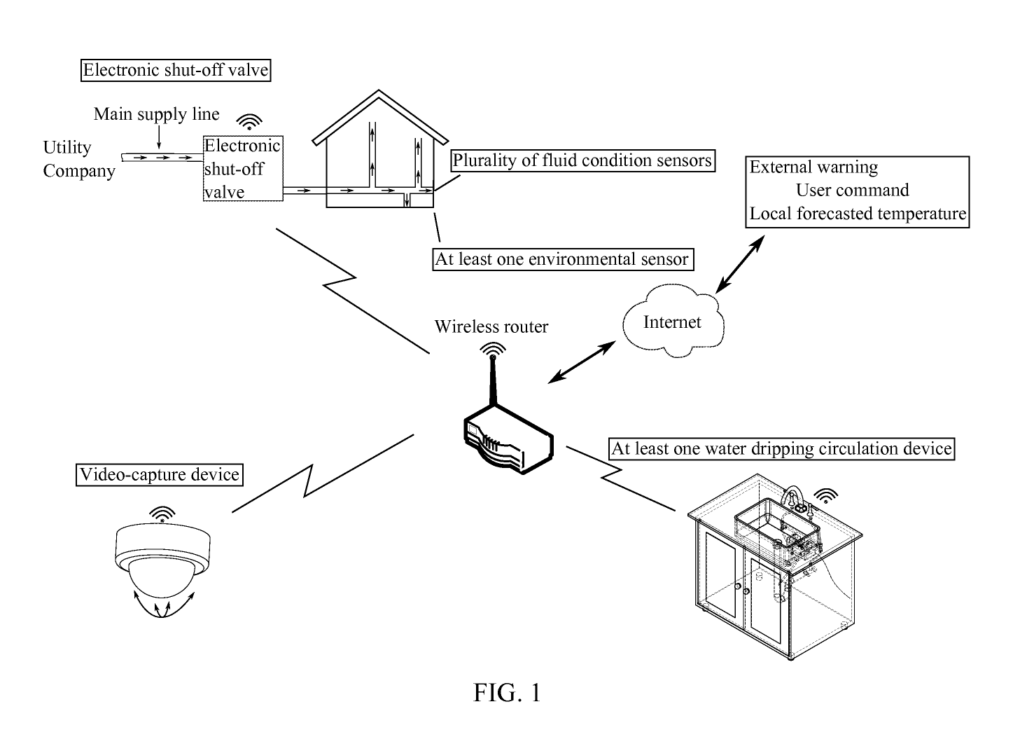

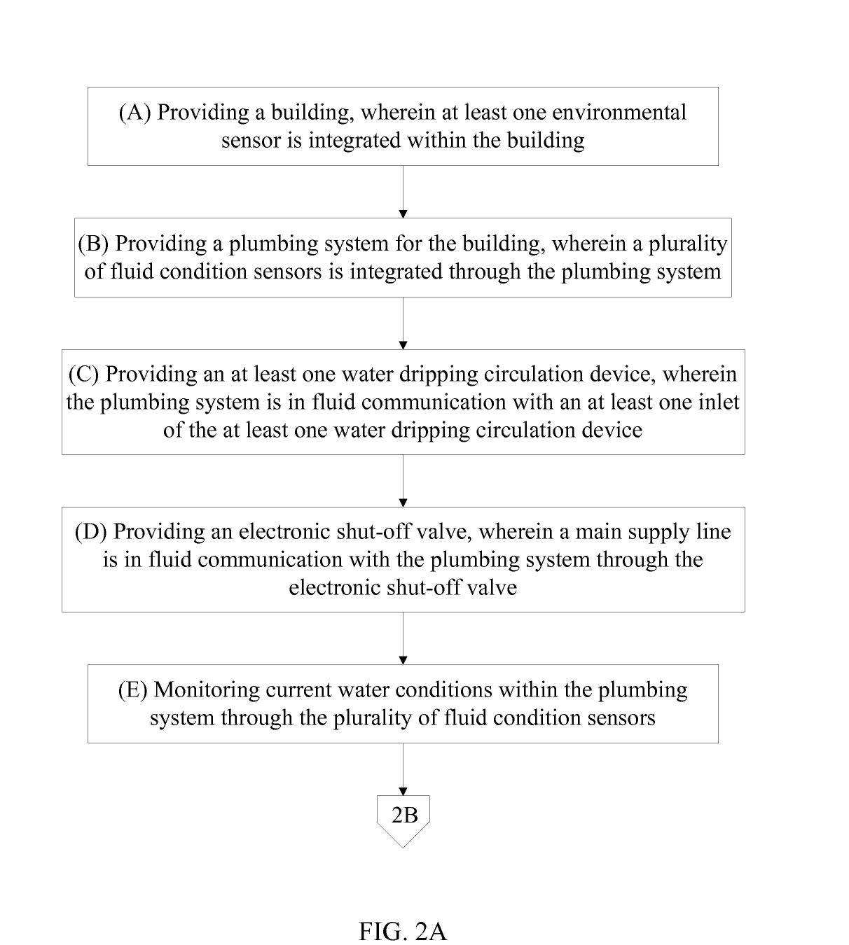

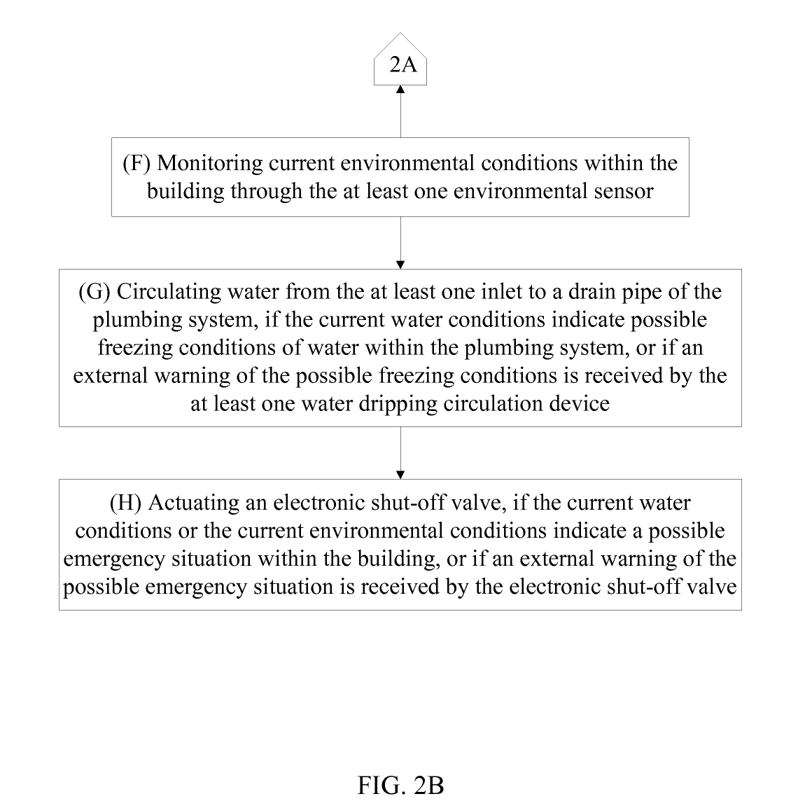

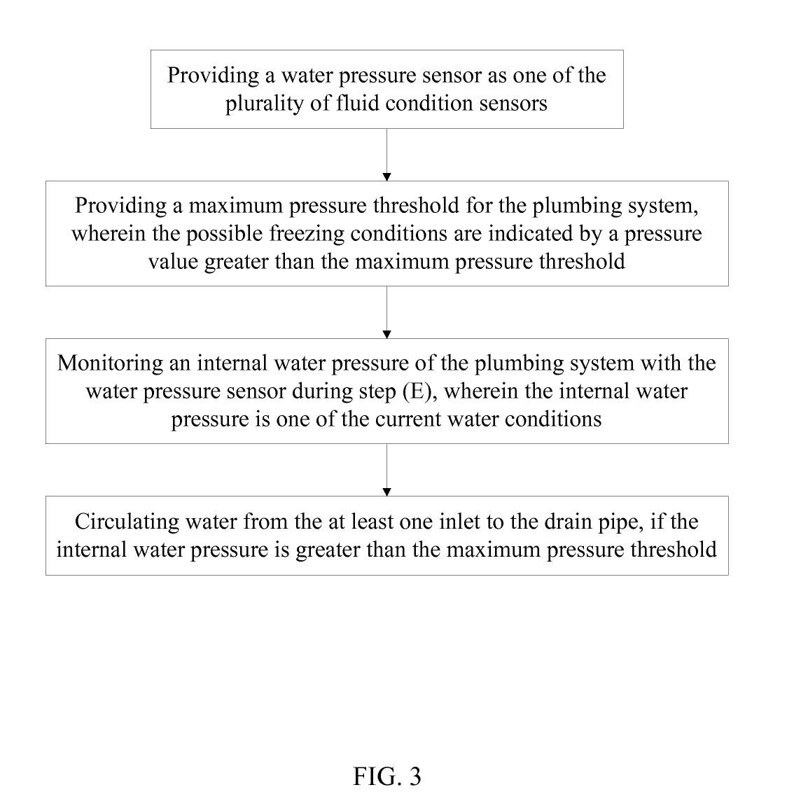

The present invention is a method of managing the internal fluid movement of a building that is designed to prevent the freezing of pipes and resultant flooding in cold conditions. A diagrammatic overview of the present invention is shown in FIG. 1 while the overall process that is followed by the present invention is illustrated in FIG. 2A and FIG. 2B. Secondary processes that are followed by the present invention are illustrated in FIGS. 3-10. An at least one environmental sensor is integrated within the building. The at least one environmental sensor may be, but is not limited to, a sensor that is capable of detecting an environmental condition that is indicative of flooding, such as the abnormal presence of water. The building contains a plumbing system throughout which a plurality of fluid condition sensors is integrated. This allows the plurality of fluid condition sensors to detect the possibility of the pipes freezing to allow for appropriate action to be taken. For example, a water temperature sensor is able to detect that the water within the plumbing system is reaching a freezing temperature.

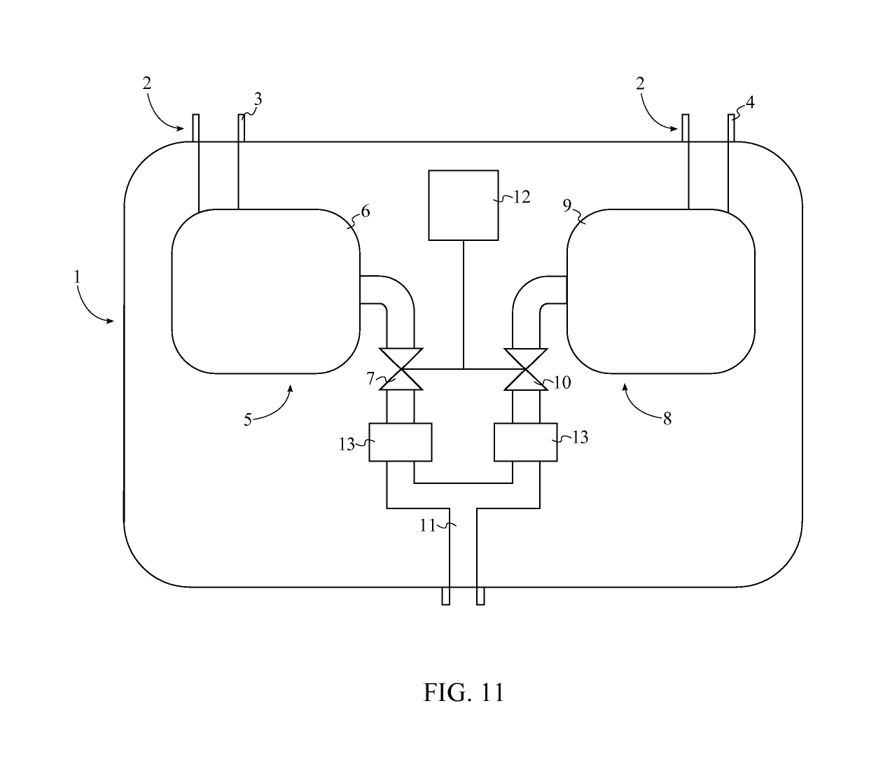

Again with reference to FIG. 2A, FIG. 2B, and FIG. 11, the present invention utilizes an at least one water dripping circulation device 1 that is able to circulate water through the plumbing system in order to prevent the pipes within the plumbing system from potentially freezing and bursting. The plumbing system is in fluid communication with an at least one inlet 2 of the at least one water dripping circulation device 1, thus allowing water from the plumbing system to enter the at least one water dripping circulation device 1 through the at least one inlet 2. The plurality of fluid condition sensors monitors current water conditions within the plumbing system. Water is circulated from the at least one inlet 2 to a drainpipe of the plumbing system in order to prevent the pipes in the plumbing system from freezing. The water is circulated if the current water conditions indicate possible freezing conditions of water within the plumbing system. These possible freezing conditions are monitored by the plurality of fluid condition sensors within the plumbing system. Alternatively, an external warning of the possible freezing conditions may be received by the at least one water dripping circulation device 1 in order to circulate water through the plumbing system. The at least one water dripping circulation device 1 is primarily designed for use with a faucet located within the building. Circulation of water through the at least one water dripping circulation device 1 may be automatically or manually engaged.

With reference to FIG. 1, FIG. 2A, and FIG. 2B, the present invention additionally utilizes an electronic shut-off valve that is able to disable the flow of water into the building. A main supply line is in fluid communication with the plumbing system through the electronic shut-off valve. The electronic shut-off valve is thus able to prevent water from the main supply line from entering the building. The at least one environmental sensor monitors current environmental conditions within the building in order to detect the presence of flooding within the building and allow for appropriate action to be taken. The electronic shut-off valve is actuated if the current water conditions or the current environmental conditions indicate a possible emergency situation within the building such as flooding. The at least one environmental sensor and the plurality of fluid condition sensors are able to detect the possible emergency situation and allow the electronic shut-off valve to disable the flow of water into the building. As such, the electronic shut-off valve is able to prevent or minimize any potential damage due to the emergency situation within the building. The electronic shut-off valve may additionally be actuated if an external warning of the possible emergency situation is received by the electronic shut-off valve. The electronic shut-off valve is automatically or manually engaged, similar to the at least one water dripping circulation device 1.

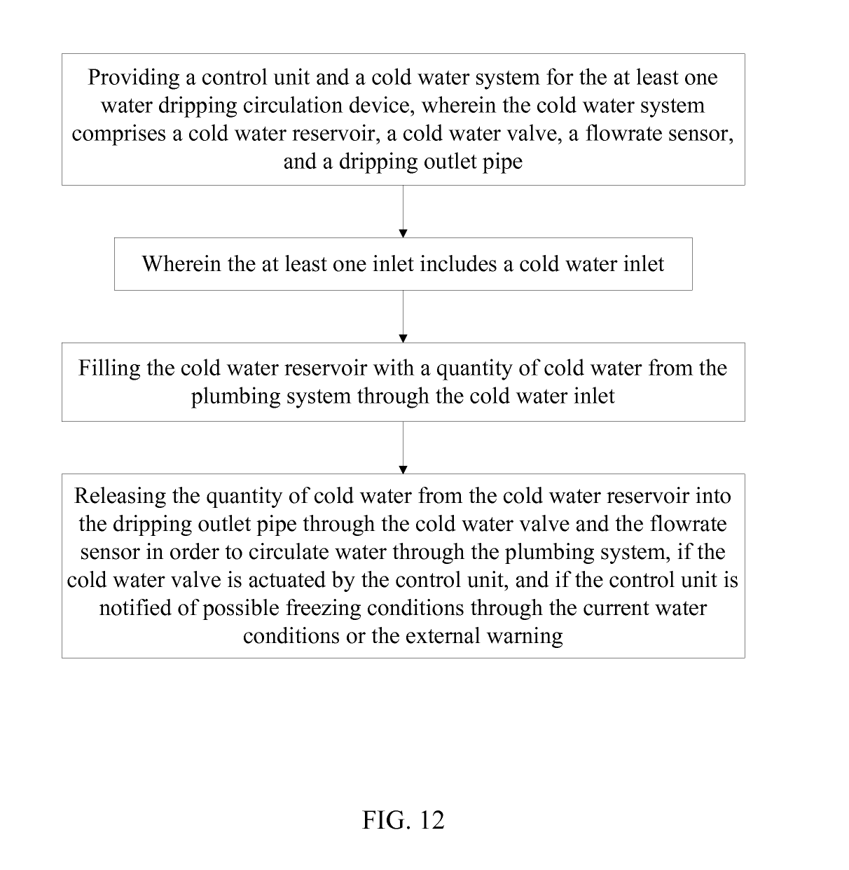

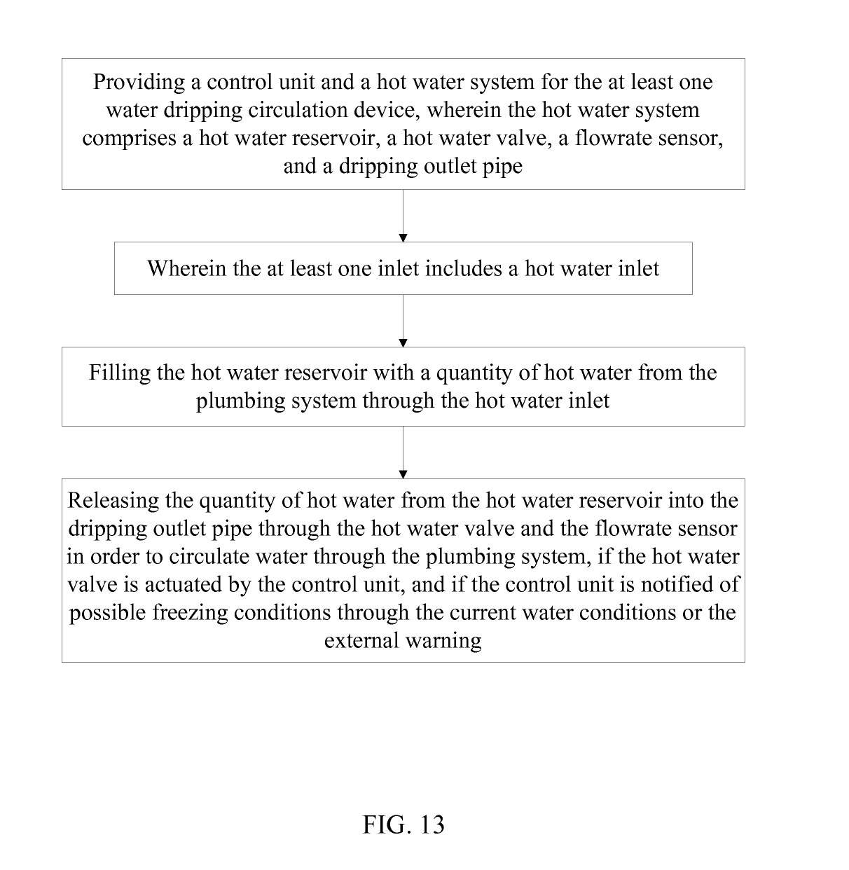

With reference to FIGS. 11-13, the at least one water dripping circulation device 1 comprises a cold water system 5, a hot water system 8, and a control unit 12 for circulating cold water and hot water through the at least one water dripping circulation device 1. The at least one inlet 2 includes a cold water inlet 3 and a hot water inlet 4. The cold water inlet 3 and the hot water inlet 4 may be connected to the cold water and hot water supply pipes of a sink or similar water source within the building.

The cold water system 5 comprises a cold water reservoir 6, a cold water valve 7, a flowrate sensor 13, and a dripping outlet pipe 11. The cold water inlet 3 is the inlet through which cold water is able to enter the at least one water dripping circulation device 1. The cold water reservoir 6 holds a quantity of cold water before the quantity of cold water is circulated out of the at least one water dripping circulation device 1 through the dripping outlet pipe 11. The dripping outlet pipe 11 is connected to the drainpipe of the sink or similar water structure within the building. The control unit 12 is able to regulate the cold water valve 7 to allow the quantity of cold water to pass through or to hold the quantity of cold water within the cold water reservoir 6. The cold water reservoir 6 is filled with the quantity of cold water from the plumbing system through the cold water inlet 3. The quantity of cold water is then released from the cold water reservoir 6 into the dripping outlet pipe 11 through the cold water valve 7 and the flowrate sensor 13 in order to circulate water through the plumbing system. The movement of the quantity of cold water from the plumbing system through the at least one water dripping circulation device 1 is able to prevent the pipes to which the cold water inlet 3 is connected from freezing. The flowrate sensor 13 is able to detect whether water is flowing through the cold water system 5. The dripping outlet pipe 11 allows for a sufficient flowrate to prevent the pipes from freezing without being wasteful. The quantity of cold water is released from the cold water reservoir 6 into the dripping outlet pipe 11 if the cold water valve 7 is actuated by the control unit 12. The cold water valve 7 is actuated by the control unit 12 if the control unit 12 is notified of possible freezing conditions through the current water conditions or the external warning. As such, the circulation of the quantity of cold water through the at least one water dripping circulation device 1 allows for the preemptive or reactive prevention of freezing of the pipes of the plumbing system that are connected to the cold water inlet 3. A water flow sensor may be positioned within the dripping outlet pipe 11 in order to determine if water is flowing through the dripping outlet pipe 11 after passing through the cold water valve 7.

Similar to the cold water system 5, the hot water system 8 comprises a hot water reservoir 9, a hot water valve 10, a flowrate sensor 13, and a dripping outlet pipe 11. The hot water inlet 4 is the inlet through which hot water is able to enter the at least one water dripping circulation device 1. The hot water reservoir 9 holds a quantity of hot water before the quantity of hot water is circulated out of the at least one water dripping circulation device 1 through the dripping outlet pipe 11. The control unit 12 regulates the hot water valve 10 and allows the quantity of hot water to pass through or holds the quantity of hot water in place within the hot water reservoir 9. The hot water reservoir 9 is filled with the quantity of hot water from the plumbing system through the hot water inlet 4. The quantity of hot water is then released from the hot water reservoir 9 into the dripping outlet pipe 11 through the hot water valve 10 and the flowrate sensor 13 in order to circulate water through the plumbing system. The movement of the quantity of hot water from the plumbing system through the at least one water dripping circulation device 1 prevents the pipes to which the hot water inlet 4 is connected from freezing. The flowrate sensor 13 is able to determine if water is flowing through the hot water system 8. The hot water valve 10 is actuated by the control unit 12 if the control unit 12 is notified of the possible freezing conditions through the current water conditions or the external warning. The circulation of the quantity of hot water through the at least one water dripping circulation device 1 allows for the preemptive or reactive prevention of the freezing of the pipes of the plumbing system that are connected to the hot water inlet 4. As previously discussed, the water flow sensor is able to determine if water is flowing through the dripping outlet pipe 11 after passing through the hot water valve 10.

With reference to FIG. 3, a water pressure sensor may be utilized as one of the plurality of fluid condition sensors. The water pressure sensor is able to detect the presence of ice that is forming within the pipes of the plumbing system due to the expansion as the water freezes. The water pressure sensor is able to monitor an internal water pressure of the plumbing system. The internal water pressure is one of the current water conditions that is indicative of possible freezing conditions. The internal water pressure is monitored by the water pressure sensor in order to determine if the internal water pressure approaches a maximum pressure threshold. The possible freezing conditions are indicated by a pressure value that is greater than the maximum pressure threshold. If the internal water pressure is greater than the maximum pressure threshold, water is circulated from the at least one inlet 2 to the drainpipe. The water circulation through the at least one water dripping circulation device 1 prevents the accumulation of ice within the pipes of the plumbing system and the subsequent pressure exerted on the pipes.

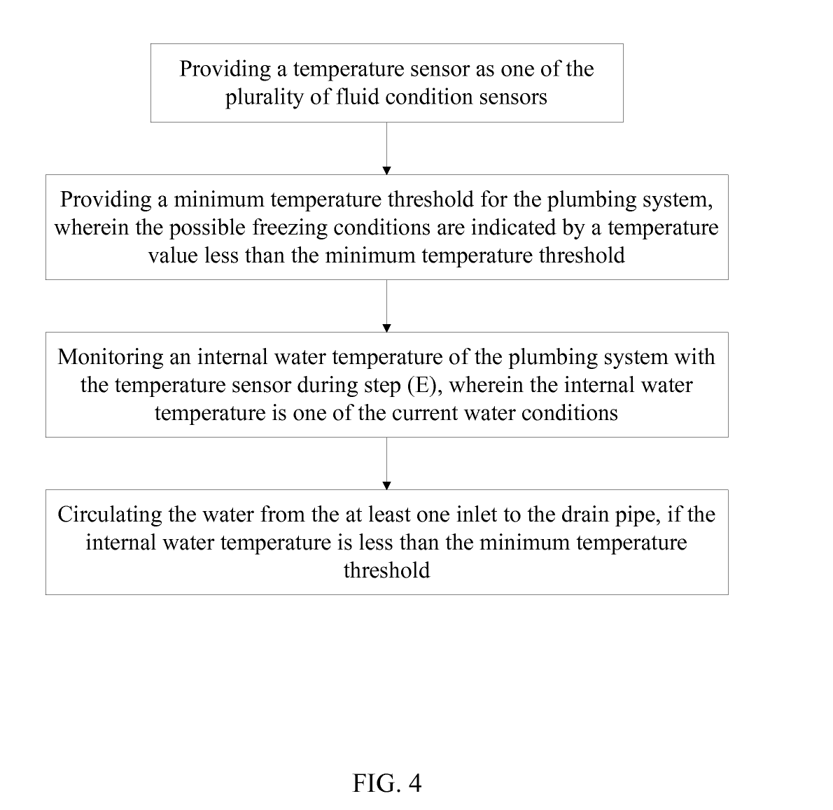

Similar to the water pressure sensor, a temperature sensor may be utilized as one of the plurality of fluid condition sensors as shown in FIG. 4. The temperature sensor detects low temperatures within the pipes of the plumbing system. The temperature sensor monitors an internal water temperature of the plumbing system that is one of the current water conditions that is indicative of possible freezing conditions. The internal water temperature is monitored by the temperature sensor in order to determine if the internal water temperature approaches a minimum temperature threshold. The possible freezing conditions are indicated by a temperature value that is less than the minimum temperature threshold. Water is circulated from the at least one inlet 2 to the drainpipe if the internal temperature is less than the minimum temperature threshold. This allows for the prevention of freezing as the water is able to circulate through the at least one water dripping circulation device 1 before freezing due to the possible freezing conditions.

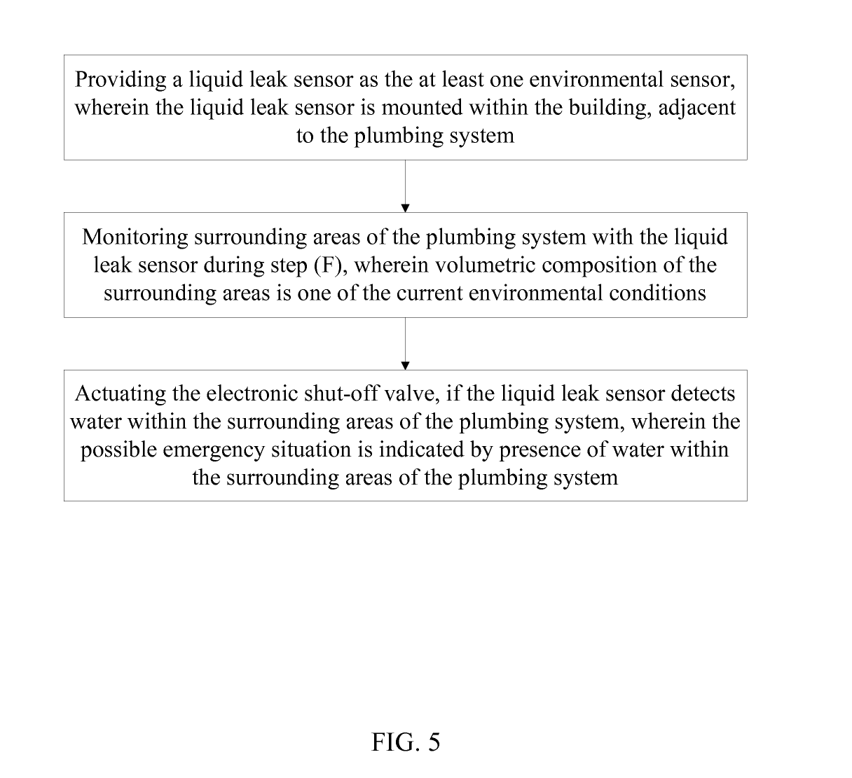

A liquid leak sensor may be utilized as the at least one environmental sensor as shown in FIG. 5. The liquid leak sensor is able to detect the presence of water due to leakage from a pipe that has burst from freezing. As such, the liquid leak sensor is mounted within the building, adjacent to the plumbing system. The liquid leak sensor is placed in close proximity to the plumbing system to allow the liquid leak sensor to immediately detect the presence of water from a burst pipe. The surrounding areas of the plumbing system are monitored by detecting water coming into physical contact with the liquid leak sensor. The volumetric composition of the surrounding areas is one of the current environmental conditions that may be indicative of a possible emergency situation within the building. The abnormal presence of water included within the volumetric composition of the surrounding areas is indicative of a possible emergency situation such as flooding in the building due to a burst pipe. The electronic shut-off valve is actuated if the liquid leak sensor detects water within the surrounding areas of the plumbing system. It is important that the liquid leak sensor is mounted in a manner such that false positives do not cause the actuation of the electronic shut-off valve (e.g. due to splashing while using a sink). The electronic shut-off valve is actuated in order to disable the flow of water into the plumbing system through the main supply line and prevent any further flooding of the building. Another example indicator of the possible emergency situation is the abnormal flow of water through the plumbing system as detected by the at least one environmental sensor. For example, if water is flowing through the plumbing system at an abnormal time of day/night or when the building is unoccupied, this may be indicative of the possible emergency situation and the electronic shut-off valve is actuated to disable the flow of water into the plumbing system. In this example, the at least one environmental sensor may be a flowrate sensor.

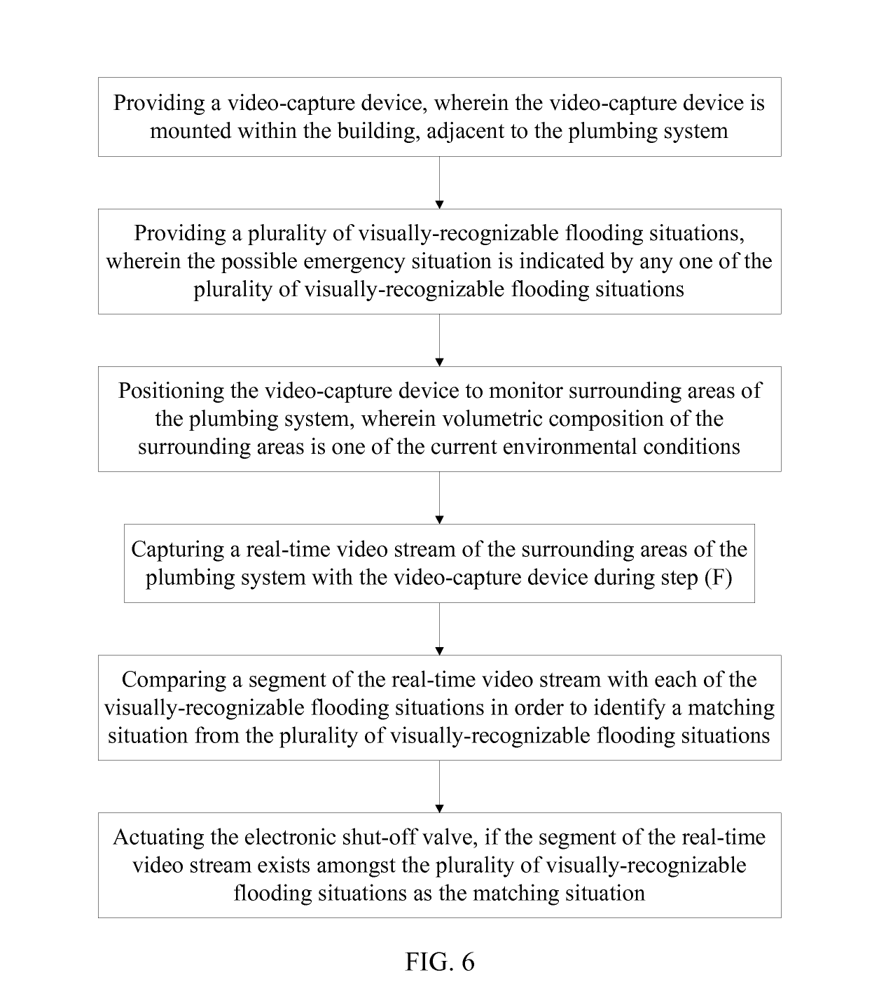

As shown in FIG. 6, a video-capture device such as a video camera may be utilized to identify a possible emergency situation within the building. The video-capture device is mounted within the building, adjacent to the plumbing system, and is able to provide a real-time video stream of a surrounding area within the building. Because the presence of water indicating flooding conditions is most prevalent adjacent to the plumbing system, the video-capture device allows for the quick identification of the flooding conditions. The video-capture device is positioned to monitor surrounding areas of the plumbing system while volumetric composition of the surrounding areas is utilized as one of the current environmental conditions that are indicative of the possible emergency situation. A plurality of visually-recognizable flooding situations such as images or video of water on the floor or water leaking from a pipe are utilized by the video-capture device. A possible emergency situation is indicated by any one of the plurality of visually-recognizable flooding situations. The real-time video stream of the surrounding areas of the plumbing system is captured with the video-capture device in order to detect the presence of a possible emergency situation. A segment of the real-time video stream is compared with each of the visually-recognizable flooding situations in order to identify a matching situation from the plurality of visually-recognizable flooding situations. For example, a segment of the real-time video stream including water visible on a floor may be matched with one of the plurality of visually-recognizable flooding situations that includes water visible on a floor. The electronic shut-off valve is then actuated if the segment of the real-time video stream exists amongst the plurality of visually-recognizable flooding situations as the matching situation. The electronic shut-off valve is thus able to disable the flow of water into the plumbing system through the main supply line and prevent further flooding of the building.

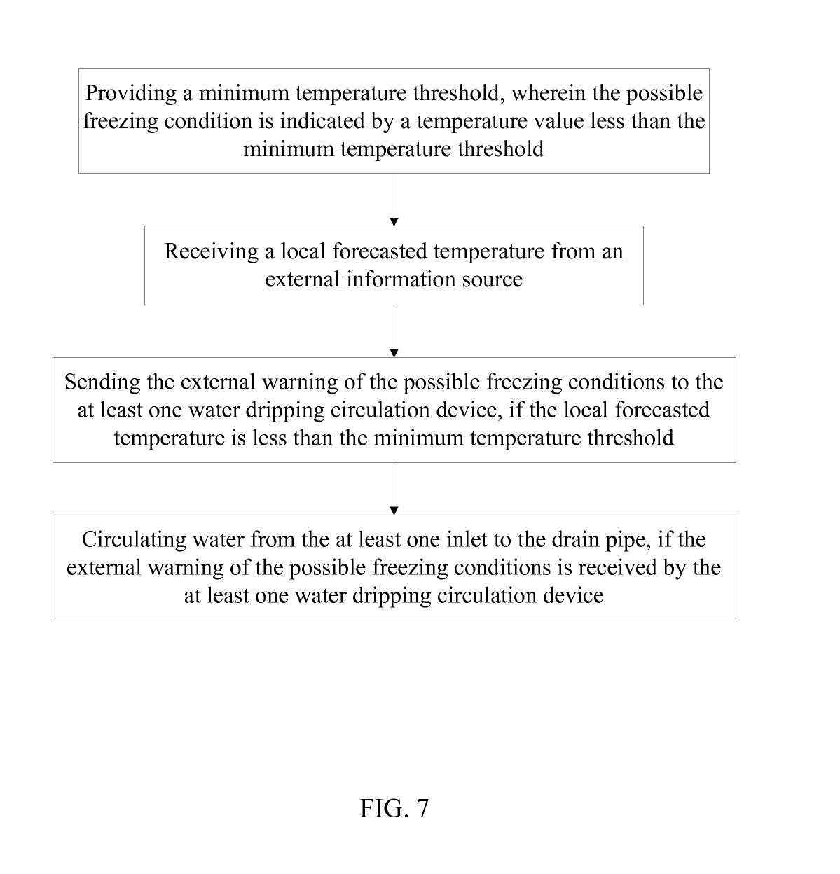

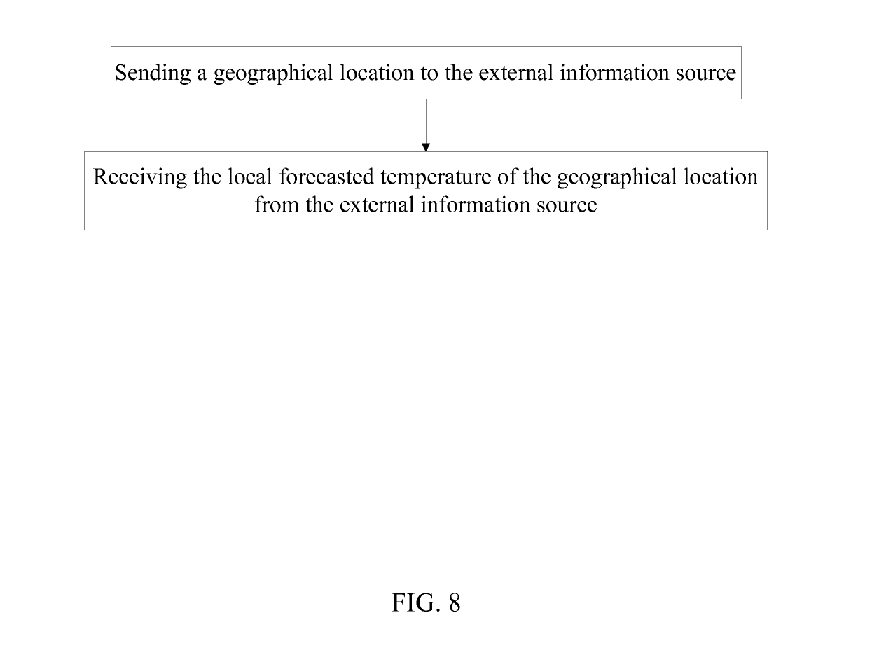

In addition to the temperature sensor and the internal water temperature of the plumbing system, a local forecasted temperature is utilized to determine if possible freezing conditions are present as shown in FIG. 7 and FIG. 8. The local forecasted temperature is indicative of a low ambient temperature within the building that may cause freezing of the plumbing system. An external information source such as a weather service is utilized to provide the local forecasted temperature. A geographical location is sent to the external information source. The geographical location relates to the location of the building as well as the plumbing system and the at least one water dripping circulation device 1. The local forecasted temperature of the geographical location is then received from the external information source. The external warning of the possible freezing conditions is sent to the at least one water dripping circulation device 1 if the local forecasted temperature is less than the minimum temperature threshold. As such, the at least one water dripping circulation device 1 is able to preemptively prevent the freezing of the plumbing system. Water is circulated from the at least one inlet 2 to the drainpipe if the external warning of the possible freezing conditions is received by the at least one water dripping circulation device 1.

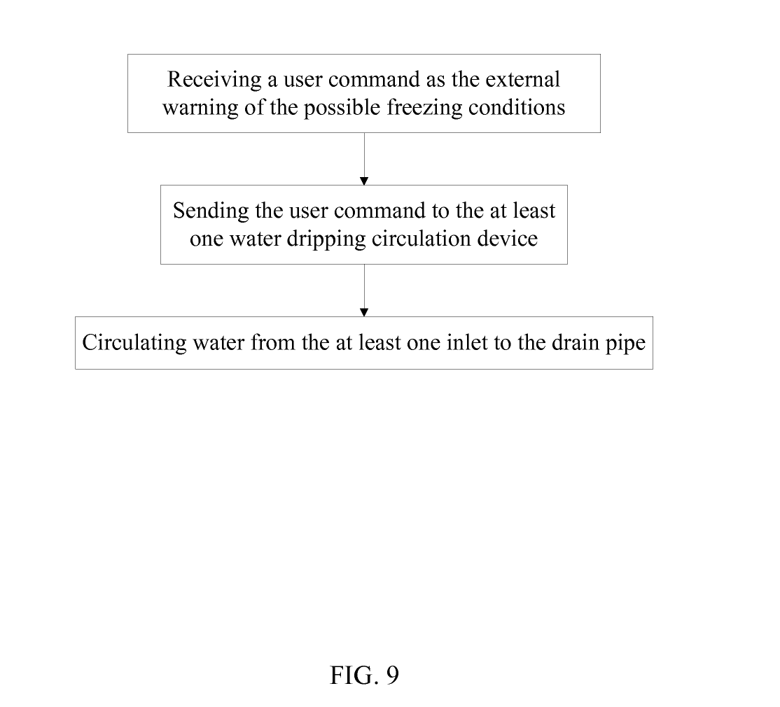

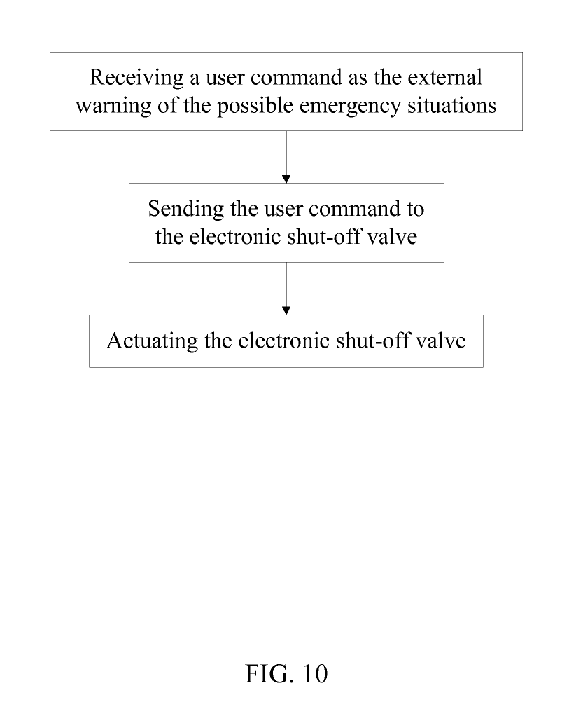

As shown in FIG. 1, the at least one water dripping circulation device 1, the electronic shut-off valve, the plurality of fluid condition sensors, and the at least one environmental sensor are communicably coupled to each other through a wireless router. This allows for wireless communication between the at least one water dripping circulation, the electronic shut-off valve, the plurality of fluid condition sensors, and the at least one environmental sensor. The plurality of fluid condition sensors and the at least one environmental sensor are thus able to transmit information to the at least one water dripping circulation device 1 and the electronic shut-off valve to prevent the freezing of the plumbing system. The wireless communication capability additionally allows for wireless user commands to be transmitted to the at least one water dripping circulation device 1 and the electronic shut-off valve. The local forecasted temperature is also wirelessly received from the external information source. As shown in FIG. 9, a user command may be received as the external warning of the possible freezing conditions. The user command is sent to the at least one water dripping circulation device 1 to allow the at least one water dripping circulation device 1 to take the appropriate action based on the user command. The water is then circulated from the at least one inlet 2 to the drainpipe. As such, the user is able to command the at least one water dripping circulation device 1 to take action to prevent the plumbing system from freezing. A user command may also be received as the external warning of the possible emergency situations within the building as shown in FIG. 10. In this case, the user command is sent to the electronic shut-off valve to allow the electronic shut-off valve to take the appropriate action based on the user command. The electronic shut-off valve is actuated and the flow of water into the building is disabled. The wireless communication additionally allows the at least one water dripping device 1 and the electronic shut-off valve to transmit emergency alerts and notifications to an external user electronic device. Emergency alerts and notifications may include information regarding the possible freezing conditions and the possible emergency situation.

In addition to preventing the building's plumbing system from freezing, the present invention may be utilized for various personal applications as well as to increase overall efficiency of water use. For example, water flow through the plumbing system may be initiated manually or automatically to initiate a water heater. The water flow may be based on a schedule. Alternatively, the user's GPS location may be wirelessly transmitted in order to ensure that heated water is available upon the user arriving at the building. In addition to disabling water flow into the building due to an emergency situation, the electronic shut-off valve may be utilized to disable water flow into the building if the building is unoccupied.

Although the present invention has been explained in relation to its preferred embodiment, it is understood that many other possible modifications and variations can be made without departing from the spirit and scope of the present invention as hereinafter claimed.

What is claimed is:

1. A method of managing the internal fluid movement of a building, the method comprises the steps of:
(A) providing a building, wherein an at least one environmental sensor is integrated within the building;
(B) providing a plumbing system for the building, wherein a plurality of fluid condition sensors is integrated through the plumbing system;
(C) providing an at least one water dripping circulation device, wherein the plumbing system is in fluid communication with an at least one inlet of the at least one water dripping circulation device;
(D) providing an electronic shut-off valve, wherein a main supply line is in fluid communication with the plumbing system through the electronic shut-off valve;
(E) monitoring current water conditions within the plumbing system through the plurality of fluid condition sensors;
(F) monitoring current environmental conditions within the building through the at least one environmental sensor;
(G) circulating water from the at least one inlet to a drainpipe of the plumbing system,
if the current water conditions indicate possible freezing conditions of water within the plumbing system,
or if an external warning of the possible freezing conditions is received by the at least one water dripping circulation device; and
(H) actuating an electronic shut-off valve,
if the current water conditions or the current environmental conditions indicate a possible emergency situation within the building,
or if an external warning of the possible emergency situation is received by the electronic shut-off valve.

2. The method of managing the internal fluid movement of a building, the method as claimed in claim 1 comprises the steps of:
providing a water pressure sensor as one of the plurality of fluid condition sensors;
providing a maximum pressure threshold for the plumbing system, wherein the possible freezing conditions are indicated by a pressure value greater than the maximum pressure threshold;
monitoring an internal water pressure of the plumbing system with the water pressure sensor during step (E), wherein the internal water pressure is one of the current water conditions; and
circulating water from the at least one inlet to the drainpipe,
if the internal water pressure is greater than the maximum pressure threshold.

3. The method of managing the internal fluid movement of a building, the method as claimed in claim 1 comprises the steps of:
providing a temperature sensor as one of the plurality of fluid condition sensors;
providing a minimum temperature threshold for the plumbing system, wherein the possible freezing conditions are indicated by a temperature value less than the minimum temperature threshold;
monitoring an internal water temperature of the plumbing system with the temperature sensor during step (E), wherein the internal water temperature is one of the current water conditions; and
circulating the water from the at least one inlet to the drainpipe,
if the internal water temperature is less than the minimum temperature threshold.

4. The method of managing the internal fluid movement of a building, the method as claimed in claim 1 comprises the steps of:
providing a liquid leak sensor as the at least one environmental sensor, wherein the liquid leak sensor is mounted within the building, adjacent to the plumbing system;
monitoring surrounding areas of the plumbing system with the liquid leak sensor during step (F), wherein volumetric composition of the surrounding areas is one of the current environmental conditions; and
actuating the electronic shut-off valve,
if the liquid leak sensor detects water within the surrounding areas of the plumbing system,
wherein the possible emergency situation is indicated by presence of water within the surrounding areas of the plumbing system.

5. The method of managing the internal fluid movement of a building, the method as claimed in claim 1 comprises the steps of:
providing a video-capture device, wherein the video-capture device is mounted within the building, adjacent to the plumbing system;
providing a plurality of visually-recognizable flooding situations, wherein the possible emergency situation is indicated by any one of the plurality of visually-recognizable flooding situations;
positioning the video-capture device to monitor surrounding areas of the plumbing system, wherein volumetric composition of the surrounding areas is one of the current environmental conditions;
capturing a real-time video stream of the surrounding areas of the plumbing system with the video-capture device during step (F);
comparing a segment of the real-time video stream with each of the visually-recognizable flooding situations in order to identify a matching situation from the plurality of visually-recognizable flooding situations; and
actuating the electronic shut-off valve,
if the segment of the real-time video stream exists amongst the plurality of visually-recognizable flooding situations as the matching situation.

6. The method of managing the internal fluid movement of a building, the method as claimed in claim 1 comprises the steps of:
providing a minimum temperature threshold, wherein the possible freezing condition is indicated by a temperature value less than the minimum temperature threshold;
receiving a local forecasted temperature from an external information source;
sending the external warning of the possible freezing conditions to the at least one water dripping circulation device,
if the local forecasted temperature is less than the minimum temperature threshold; and
circulating water from the at least one inlet to the drainpipe,
if the external warning of the possible freezing conditions is received by the at least one water dripping circulation device.

7. The method of managing the internal fluid movement of a building, the method as claimed in claim 6 comprises the steps of:
sending a geographical location to the external information source; and
receiving the local forecasted temperature of the geographical location from the external information source.

8. The method of managing the internal fluid movement of a building, the method as claimed in claim 1 comprises the steps of:
receiving a user command as the external warning of the possible freezing conditions;
sending the user command to the at least one water dripping circulation device; and
circulating water from the at least one inlet to the drainpipe.

9. The method of managing the internal fluid movement of a building, the method as claimed in claim 1 comprises the steps of:
receiving a user command as the external warning of the possible emergency situations;
sending the user command to the electronic shut-off valve; and
actuating the electronic shut-off valve.

10. The method of managing the internal fluid movement of a building, the method as claimed in claim 1 comprises the steps of:
the at least one water dripping circulation device, the electronic shut-off valve, the plurality of fluid condition sensors, and the at least one environmental sensor being communicably coupled to each other through a wireless router.

11. The method of managing the internal fluid movement of a building, the method as claimed in claim 1 comprises the steps of:
providing a control unit and a cold water system for the at least one water dripping circulation device, wherein the cold water system comprises a cold water reservoir, a cold water valve, a flowrate sensor, and a dripping outlet pipe;
wherein the at least one inlet includes a cold water inlet;
filling the cold water reservoir with a quantity of cold water from the plumbing system through the cold water inlet; and
releasing the quantity of cold water from the cold water reservoir into the dripping outlet pipe through the cold water valve and the flowrate sensor in order to circulate water through the plumbing system,
if the cold water valve is actuated by the control unit,
and if the control unit is notified of possible freezing conditions through the current water conditions or the external warning.

12. The method of managing the internal fluid movement of a building, the method as claimed in claim 1 comprises the steps of:
providing a control unit and a hot water system for the at least one water dripping circulation device, wherein the hot water system comprises a hot water reservoir, a hot water valve, a flowrate sensor, and a dripping outlet pipe;
wherein the at least one inlet includes a hot water inlet;
filling the hot water reservoir with a quantity of hot water from the plumbing system through the hot water inlet; and
releasing the quantity of hot water from the hot water reservoir into the dripping outlet pipe through the hot water valve in order to circulate water through the plumbing system,
if the hot water valve is actuated by the control unit,
and if the control unit is notified of possible freezing conditions through the current water conditions or the external warning.
